(19) United States
(12) Patent Application Publication
(10) Pub. No.: US 2012/0018515 A1
(43) Pub. Date: Jan. 26, 2012

(54) COMMODITY CODE READING APPARATUS AND CONTROL METHOD

(75) Inventors: Tomonari Kakino, Shizuoka (JP); Yoshitaka Inagi, Shizuoka (JP)

(73) Assignee: TOSHIBA TEC KABUSHIKI KAISHA, Tokyo (JP)

(21) Appl. No.: 13/180,648

(22) Filed: Jul. 12, 2011

(30) Foreign Application Priority Data
Jul. 21, 2010 (JP) 2010-163866

(51) Int. Cl. G06K 7/14

(52) U.S. Cl. 235/454

(57) ABSTRACT

A commodity code reading apparatus includes: an image capturing section configured to sequentially capture a frame image picked up by an image pick up section; a code detecting section configured to detect a code symbol included in the captured frame image; a decoding section configured to decode a commodity code from the detected code symbol; a position storing section configured to store the position of the detected code symbol in the frame image; a determining section configured to determine whether the position of the detected code symbol and the position of a code symbol already stored in the position storing section are close to each other; a count section configured to count, over a plurality of the sequentially-captured frame images, the number of times the determining section determines that the positions are close to each other; and an informing section configured to inform, if the counted number of times reaches the number of times set in advance, that it is likely that basket reading of a commodity code occurs. The apparatus outputs, as a commodity code read from a commodity, a commodity code obtained by decoding a code symbol, a position of which is determined by the determining section as not close.

### CROSS-REFERENCE TO RELATED APPLICATION

This application is based upon and claims the benefit of priority from the prior Japanese Patent Application No. 2010-163866, filed on Jul. 21, 2010; the entire contents of which are incorporated herein by reference.

### FIELD

Embodiments described herein relate generally to a commodity code reading apparatus and a control method.

### BACKGROUND

In the past, in a supermarket or the like, a commodity code reading apparatus is used that picks up, with a digital camera of a CCD image sensor or the like, an image of a code symbol such as a barcode or a two-dimensional code (e.g., a QR code (registered trademark)) affixed to a commodity, detects the code symbol from the picked-up image, and decodes the code symbol to read a commodity code. A store clerk takes out commodities stored in a shopping basket, which a customer carries onto a counter table, and holds the commodities over the digital camera of the commodity code reading apparatus to register the commodities to be purchased by the customer. The registered commodities are sequentially stored in an empty shopping basket prepared downstream on the counter table in advance.

In the commodity registration work, if the shopping basket prepared downstream is placed in a readable range of the commodity code reading apparatus, the commodities already read and stored in the shopping basket are read again by mistake. Therefore, in some case, basket reading occurs.

### DESCRIPTION OF THE DRAWINGS

FIG. 1 is a perspective view of a checkout system according to an embodiment;

FIG. 2 is a block diagram of hardware configurations of a POS terminal and a commodity code reading apparatus according to the embodiment;

FIG. 3 is a block diagram of a functional configuration of a CPU;

FIG. 4 is a flowchart for explaining an example of the operation of the commodity code reading apparatus according to the embodiment;

FIG. 5 is a conceptual diagram of an example of a barcode informed in a reading region; and

FIG. 6 is a conceptual diagram of an example of overlap display.

### DETAILED DESCRIPTION

In general, according to one embodiment, a commodity code reading apparatus includes: an image capturing section configured to sequentially capture a frame image picked up by an image pickup section; a code detecting section configured to detect a code symbol included in the captured frame image; a decoding section configured to decode a commodity code from the detected code symbol; a position storing section configured to store the position of the detected code symbol in the frame image; a determining section configured to determine whether the position of the detected code symbol and the position of a code symbol already stored in the position storing section are close to each other; a count section configured to count, over a plurality of the sequentially-captured frame images, the number of times the determining section determines that the positions are close to each other; and an informing section configured to inform, if the counted number of times reaches the number of times set in advance, that it is likely that basket reading of a commodity code occurs. The commodity code reading apparatus outputs, as a commodity code read from a commodity, a commodity code obtained by decoding a code symbol, a position of which is determined by the determining section as not close to the position of the code symbol already stored in the position storing section.

In general, according to another embodiment, a control method for a commodity code reading apparatus includes: sequentially capturing a frame image picked up by an image pickup section; detecting a code symbol included in the captured frame image; decoding a commodity code from the detected code symbol; storing the position of the detected code symbol in the frame image; determining whether the position of the detected code symbol and the position of an already-stored code symbol are close to each other; counting, over a plurality of the sequentially-captured frame images, the number of times it is determined that the positions are close to each other; and informing, if the counted number of times reaches the number of times set in advance, that it is likely that basket reading of a commodity code occurs. A commodity code obtained by decoding a code symbol, a position of which is determined as not close to the position of the code symbol already stored in the position storing section, is output as a commodity code read from a commodity.

A commodity code reading apparatus and a control method according to an embodiment are explained below with reference to the accompanying drawings using a checkout system as an example. The checkout system is a POS terminal or the like that performs registration and settlement of commodities purchased in one transaction. This embodiment is an example of application to a checkout system installed in a store such as a restaurant or a supermarket.

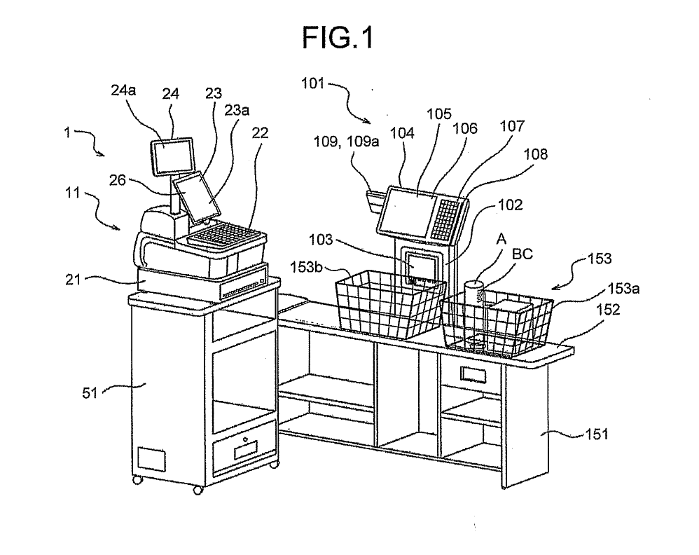

FIG. 1 is a perspective view of a checkout system 1. As shown in FIG. 1, the checkout system 1 includes a POS terminal 11 configured to perform registration and settlement of commodities purchased in one transaction. The POS terminal 11 is placed on the upper surface of a drawer 21 on a checkout table 51. The drawer 21 is subjected to control for an opening operation by the POS terminal 11. A keyboard 22 pressed by an operator (a user) is arranged on the upper surface of the POS terminal 11. A display device 23 configured to display information to the operator is provided further on the rear side than the keyboard 22 viewed from the operator who operates the keyboard 22. The display device 23 displays information on a display surface 23a thereof. A touch panel 26 is laminated on the display surface 23a. A customer display device 24 is rotatably vertically provided further on the rear side than the display device 23. The customer display device 24 displays information on a display surface 24a thereof. In the customer display device 24 shown in FIG. 1, the display surface 24a is faced to the front side in FIG. 1. However, the customer display device 24 is rotated to make the display surface 24a face to the rear side in FIG. 1, whereby the customer display device 24 displays information to a customer.

A counter table 151 having an elongated table shape is arranged to form an L shape with the checkout table 51 on which the POS terminal 11 is arranged. A loading surface 152 is formed on the upper surface of the counter table 151. A shopping basket 153 including a commodity A affixed with a barcode BC is placed on the loading surface 152. The shopping basket 153 can be considered either a shopping basket 153a carried in by the customer or a second shopping basket 153b located on a downstream side parallel to a moving direction of the customer.

A commodity code reading apparatus 101 connected to the POS terminal 11 to be capable of freely transmit and receive data to and from the POS terminal 11 is set on the loading surface 152 of the counter table 151. The commodity code reading apparatus 101 includes a housing 102 having a thin rectangular shape. A reading window 103 is arranged on the front surface of the housing 102. A display and operation section 104 is attached to the upper part of the housing 102. A display device 106, on the surface of which a touch panel 105 is laminated, is provided in the display and operation section 104. A keyboard 107 is disposed on the right of the display device 106. A card reading groove 108 of a not-shown card reader is provided on the right of the keyboard 107. A customer display device 109 for providing the customer with information is set on the left rear side on the rear surface of the display and operation section 104 viewed from the operator. A customer touch panel 109a is laminated on a display surface of the customer display device 109.

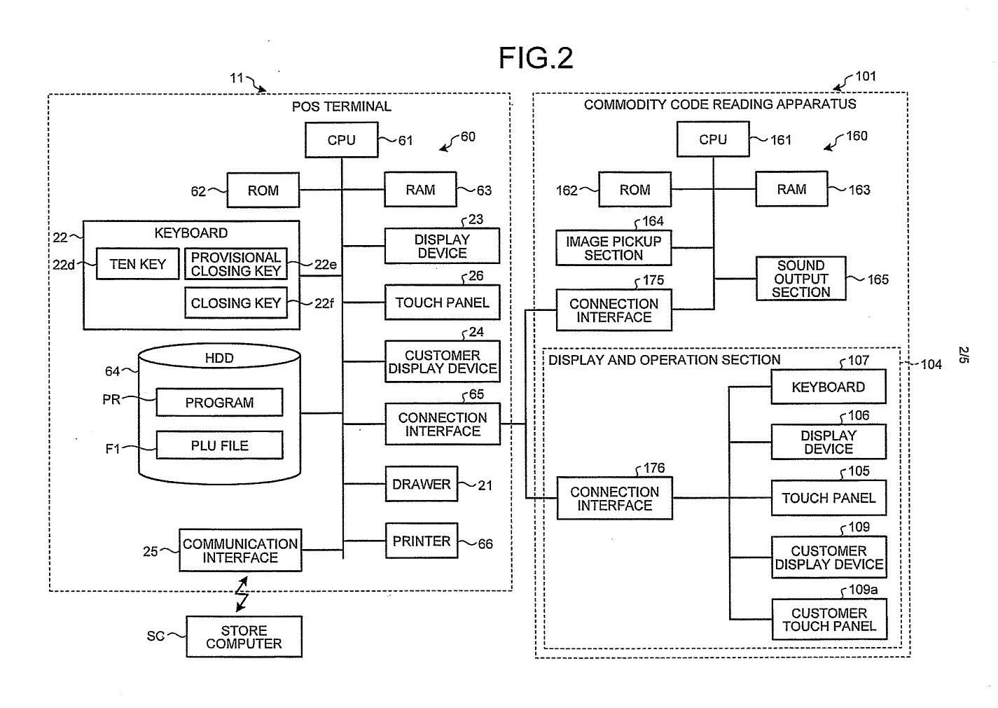

The commodity A purchased in one transaction is stored in the first shopping basket 153a carried in by the customer. The barcode BC in which a commodity code concerning the commodity A is encoded is affixed to the commodity A. The commodity A is moved to the second shopping basket 153b by a hand of the operator. In a process of this movement, the barcode BC is made to face to the reading window 103 of the commodity code reading apparatus 101. At this point, an image pickup section 164 (see FIG. 2) arranged on the inner side of the reading window 103 picks up an image of the barcode BC. The commodity code reading apparatus 101 detects and decodes the barcode BC included in the image picked up by the image pickup section 164 to read the commodity code concerning the commodity A. The commodity code described as the barcode BC is a code allocated to each commodity to specify the commodity A. As an example, the commodity code is a JAN code, which is a thirteen-digit number. In this embodiment, the barcode BC is explained as an example of a code symbol. However, it goes without saying that the code symbol may be a two-dimensional code such as a QR code (registered trademark).

FIG. 2 is a block diagram of hardware configurations of the POS terminal 11 and the commodity code reading apparatus 101. The POS terminal 11 includes a microcomputer 60 functioning as an information processing section configured to execute information processing. In the microcomputer 60, a ROM (Read Only Memory) 62 and a RAM (Random Access Memory) 63 are connected, via a bus, to a CPU (Central Processing Unit) configured to executes various kinds of arithmetic processing and control sections.

The drawer 21, the keyboard 22, the display device 23, the touch panel 26, and the customer display device 24 are connected to the CPU 61 of the POS terminal 11 respectively via various input and output circuits (all of which are not shown). These sections are subjected to control by the CPU 61.

The keyboard 22 includes a ten key 22d, on the upper surface of which numbers such as “1”, “2”, and “3” and a multiplication operator “x” are displayed, a provisional closing key 22e, and a closing key 22f. The keyboard 22 outputs an operation input by the operator via the ten key 22d, the provisional closing key 22e, and the closing key 22f to the CPU 61. The keyboard 22 is one of operation means for receiving operation from the operator.

A HDD (Hard Disk Drive) 64 is connected to the CPU 61 of the POS terminal 11. Computer programs and various files are stored in the HDD 64. All or a part of the computer programs and the various files stored in the HDD 64 are copied to the RAM 63 and sequentially executed by the CPU 61 when the POS terminal 11 is started. An example of the computer programs stored in the HDD 64 is a computer program PR for commodity sales data processing. An example of the files stored in the HDD 64 is a FLU file F1 distributed from a store computer SC and stored in the HDD 64. The FLU file F1 is a file in which, for respective commodity codes uniquely allocated to respective commodities, information concerning the commodities such as names, unit prices, and commodity classification is stored.

A communication interface 25 for executing data communication with the store computer SC is connected to the CPU 61 of the POS terminal 11 via an input and output circuit (not shown). The store computer SC is set in a backyard or the like of the store. The FLU file F1 distributed to the POS terminal 11 is stored in a HDD (not shown) of the store computer SC.

Further, a connection interface 65 configured to enable data transmission and reception between the POS terminal 11 and the commodity code reading apparatus 101 is connected to the CPU 61 of the POS terminal 11. Therefore, the connection interface 65 is connected to the commodity code reading apparatus 101. A printer 66 configured to perform printing on a receipt or the like is also connected to the CPU 61 of the POS terminal 11. The POS terminal 11 prints transaction contents of one transaction on the receipt under the control by the CPU 61.

The commodity code reading apparatus 101 includes a microcomputer 160. In the microcomputer 160, a ROM 162 and a RAM 163 are connected to a CPU 161 via a bus. A computer program executed by the CPU 161 is stored in the ROM 162. The image pickup section 164 and a sound output section 165 are connected to the CPU 161 via various input and output circuits (all of which are not shown). The operations of the image pickup section 164 and the sound output section 165 are controlled by the CPU 161. The display and operation section 104 is connected to the POS terminal 11 via a connection interface 176. The operation of the display and operation section 104 is controlled by the CPU 61 of the POS terminal 11.

The image pickup section 164 is a CCD image sensor, a CMOS image sensor, or the like and performs image pickup from the reading window 103 under the control by the CPU 161. For example, the image pickup section 164 performs image pickup of a 30 fps moving image. Frame images sequentially picked up by the image pickup section 164 at a predetermined frame rate are stored in the RAM 163. The sound output section 165 is a sound circuit, a speaker, or the like for generating alarm sound or the like set in advance. The sound output section 165 performs alerting by sound such as alarm sound under the control by the CPU 161.

A connection interface 175 connected to the connection interface 65 of the POS terminal 11 and enabling data transmission and reception between the commodity code reading apparatus 101 and the POS terminal 11 is connected to the CPU 161. Under the control by the CPU 161, a commodity code read from an image picked up by the image pickup section 164 of the commodity code reading apparatus 101 is output via the connection interface 175 and input to the POS terminal 11 via the connection interface 65.

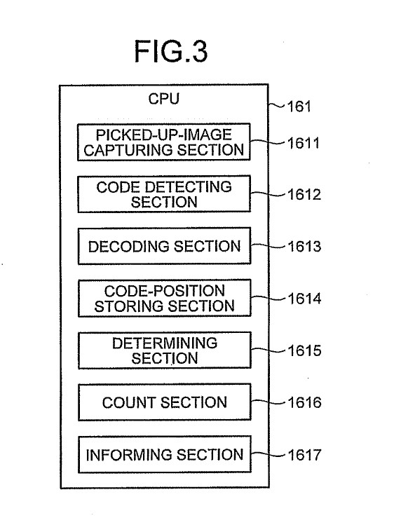

Functional sections of the commodity code reading apparatus 101 realized by the CPU 161 sequentially executing computer programs are explained with reference to FIG. 3. FIG. 3 is a block diagram of a functional configuration of the CPU 161. As shown in FIG. 3, the CPU 161 sequentially executes the computer programs to thereby include functions of a picked-up-image capturing section 1611, a code detecting section 1612, a decoding section 1613, a code-position storing section 1614, a determining section 1615, a count section 1616, and an informing section 1617.

The picked-up-image capturing section 1611 sequentially captures frame images picked up by the image pickup section 164 and stored in the RAM 163. The capturing of the frame images by the picked-up-image capturing section 1611 is performed in order of storage in the RAM 163. The code detecting section 1612 detects code symbols included in the frame images captured by the picked-up-image capturing section 1611. Specifically, the code detecting section 1612 performs, for example, detection of the barcode BC by a pattern matching technique from the captured frame images and detection of a two-dimensional code from a predetermined finder pattern. The decoding section 1613 decodes commodity codes from the code symbols detected by the code detecting section 1612.

The code-position storing section 1614 stores the positions in the frame images of the code symbols detected by the code detecting section 1612 in a work area of the RAM 163. The storage of the positions concerning the code symbols is performed by stacking the positions of the code symbols, which are detected by the code detecting section 1612 for each of the sequentially-captured frame images, in the work area of the RAM 163. The code-position storing section 1614 stores information indicating the positions in the frame images of the code symbols detected by the code detecting section 1612 in association with the commodity codes obtained by decoding the code symbols with the decoding section 1613. Since the positions in the frame images of the detected code symbols are stored by the code-position storing section 1614, the commodity code reading apparatus 101 can compare the positions of code symbols detected from previous frame images and already stacked and the positions of code symbols detected anew. Since the information indicating the positions of the code symbols is stored in association with the commodity code obtained by decoding the code symbols, the commodity code reading apparatus 101 can compare commodity codes of code symbols detected from previous frame images and already stacked and commodity codes of code symbols detected anew.

The determining section 1615 determines whether the position of a code symbol detected by the code detecting section 1612 and the positions of the code symbols already stored in the code-position storing section 1614 are close to each other. Specifically, the determining section 1615 reads out the positions of the code symbols stacked in the RAM 163 by the code-position storing section 1614 and acquires a position closest to the position of the detected code symbol among the read-out positions. Subsequently, the determining section 1615 determines whether a distance between the position of the detected code symbol and the position of the code symbol closest to the position of the code symbol is within a range set in advance and determines whether the positions are close to each other. According to the determination by the determining section 1615, for example, if the position of the code symbol detected from a previous frame image and the position of a code symbol detected from the present frame image are the same, it is determined that the positions are close to each other.

The count section 1616 counts, over a plurality of the frame images, the numbers of times the determining section 1615 determines that positions are close to each other (the numbers of counts of closeness and coincidence). Specifically, the count section 1616 stores the numbers of counts in association with the positions of the code symbols stacked in the RAM 163 by the code-position storing section 1614. The count section 1616 increments the number of counts stored in association with the position of a symbol code determined as being close to the position of a code symbol detected from a frame image. The CPU 161 repeats the determination by the determining section 1615 and the count by the count section 1616 over the plurality of the frame images, whereby code symbols, positions of which do not change among the plurality of the frame images, are counted as code symbols close to one another.

If the number of counts by the count section 1616 reaches the number of times (a predetermined number) set in advance in the ROM 162 or the like, the informing section 1617 informs the operator through alarm sound by the sound output section 165, a warning screen by the display device 106, or the like that it is likely that basket reading of a commodity code occurs. The basket reading indicates that an already-read commodity in a shopping basket is read again by mistake. For example, if the number of counts by the count section 1616 is equal to or larger than the predetermined value, since the position of a code symbol does not move over the plurality of the frame images, it is estimated that the barcode BC of the commodity A in the second shopping basket 153b placed on the loading surface 152 is reflected on the image pickup section 164. More specifically, if the position of the code symbol does not move for about one second, since it is likely that the barcode BC of the commodity A in the second shopping basket 153b is reflected, 30 frames is set as the predetermined value in advance assuming that frame images are sequentially captured at 30 fps. Therefore, if the number of counts by the count section 1616 is equal to or larger than the predetermined value, the informing section 1617 informs the operator through sound or screen display that it is likely that the barcode BC of the already-registered commodity A in the second shopping basket 153b is read again. Consequently, the operator can prevent occurrence of basket reading by changing the direction of the commodity A such that the barcode BC of the commodity A in the second shopping basket 153b is not read again.

If the number of counts by the count section 1616 reaches the predetermined value, the informing section 1617 may inform the operator as explained above if the position of a code symbol associated with the number of counts is included in a predetermined region in a frame image. Specifically, in the frame image, the predetermined region is, for example, a region where the barcode BC of the commodity A in the second shopping basket 153b is estimated to be reflected, which is a region below the center of the frame image. In this way, the position of the code symbol to be informed is limited to the region where the barcode BC of the commodity A in the second shopping basket 153b is estimated to be reflected. This makes it possible to accurately inform the operator that it is likely that the barcode BC of the commodity A is read again.

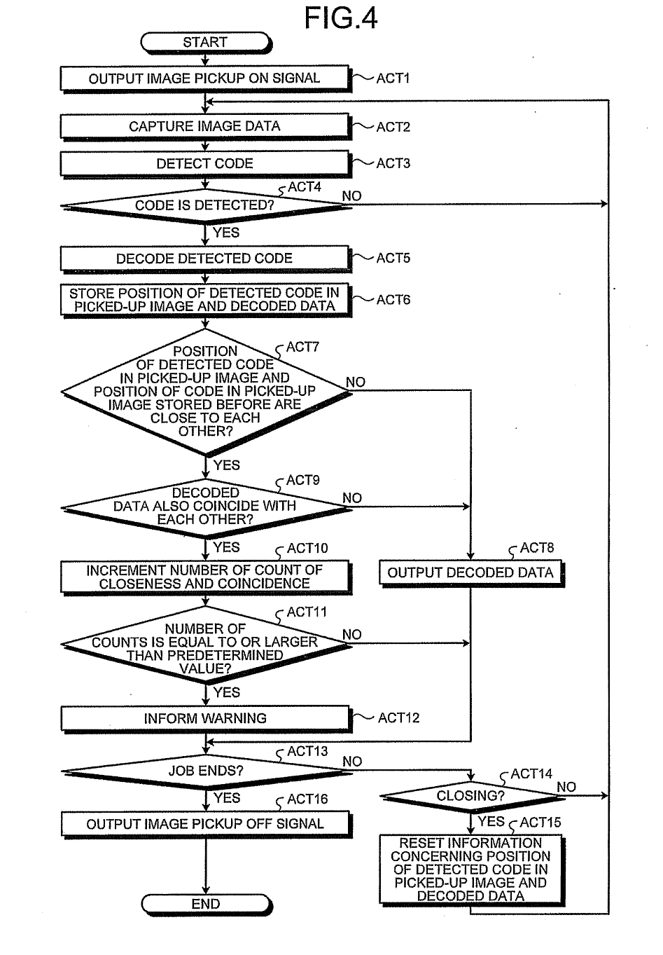

The operation of the commodity code reading apparatus 101 is explained in detail. FIG. 4 is a flowchart for explaining an example of the operation of the commodity code reading apparatus 101 according to this embodiment.

As shown in FIG. 4, when processing is started according to, for example, the start of commodity registration by the POS terminal 11, the CPU 161 outputs an image pickup ON signal to the image pickup section 164 and starts image pickup by the image pickup section 164 (Act 1). Subsequently, the picked-up-image capturing section 1611 captures a frame image (picked-up image) picked up by the image pickup section 164 and stored in the RAM 163 (Act 2). The code detecting section 1612 detects a code symbol included in the frame image captured by the picked-up-image capturing section 1611 (Act 3).

The determining section 1615 determines whether a code symbol is detected in Act 3 (Act 4). If a code symbol is not detected (NO in Act 4), the CPU 161 returns the processing to Act 2 and performs processing for the next frame image.

If a code symbol is detected (YES in Act 4), the decoding section 1613 decodes the detected code symbol (Act 5). The code-position storing section 1614 stores the position in the frame image of the detected code symbol and a commodity code decoded by the decoding section 1613 in the RAM 163 in association with each other (Act 6).

The determining section 1615 determines whether the position of the detected code symbol and the position of a code symbol in a frame image stored before, which is already stored in the RAM 163 by the code-position storing section 1614, are close to each other (Act 7). If the positions are close to each other (YES in Act 7), the determining section 1615 determines whether commodity codes obtained by decoding the code symbols close to each other coincide with each other (Act 9). In this way, it is determined whether the commodity codes coincide with each other. This makes it possible to discriminate whether code symbols close to one another among the plurality of the frame images are the same code symbols.

If the positions are not close to each other (NO in Act 7) or if the commodity codes obtained by decoding the code symbols close to each other do not coincide with each other (NO in Act 9), it is estimated that the barcode BC of the commodity A in the second shopping basket 153b is not reflected on the image pickup section 164 and read. Therefore, in the case of NO in Act 7 or NO in Act 9, the CPU 161 outputs the commodity code decoded by the decoding section 1613 from the code symbol detected by the code detecting section 1612 to the POS terminal 11 (Act 8).

If the commodity codes obtained by decoding the code symbols close to each other coincide with each other (YES in Act 9), the frame image is assumed to be a frame image of the barcode BC of the commodity A in the second shopping basket 153b reflected on the image pickup section 164. Therefore, in the case of YES in Act 9, the count section 1616 increments the number of counts of closeness and coincidence (Act 10). Subsequently, the informing section 1617 determines whether the number of counts by the count section 1616 is equal to or larger than the predetermined value (Act 11).

If the number of counts is equal to or larger than the predetermined value (YES in Act 11), it is likely that the barcode BC of the commodity A in the second shopping basket 153b is reflected. Therefore, the informing section 1617 informs the operator through alarm sound by the sound output section 165, the warning screen by the display device 106, or the like, that it is likely that basket reading of a commodity code occurs (Act 12).

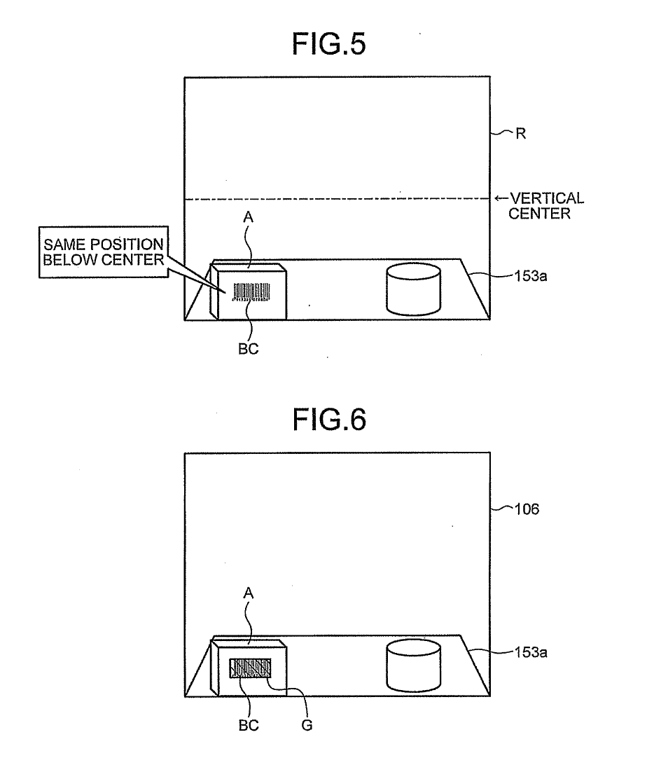

As explained above, in Act 12, if the position of the code symbol associated with the number of counts is included in a predetermined region of the frame image, the informing section 1617 may inform the operator that it is likely that basket reading of a commodity code occurs. Specifically, as shown in FIG. 5, if the barcode BC included in a region lower than the center is present in the same position in a reading region R equivalent to the frame image, the informing section 1617 may inform the operator that it is likely that basket reading of a commodity code occurs.

On the warning screen by the display device 106, the position of the code symbol determined as close, the number of counts of which is determined as equal to or larger than the predetermined value, may be displayed to overlap the frame image picked up by the image pickup section 164. Specifically, as shown in FIG. 6, the CPU 161 causes, on the basis of the position of the code symbol stored in the RAM 163 in association with the number of counts, the display device 106 to display a warning screen in which a marker G such as half-tone dot meshing or an icon is displayed to overlap the barcode BC. The display on the display device 106 is performed under the control by the CPU 61 by notifying the CPU 61 of display data generated by the count section 1616. The count section 1616 may notify the CPU 61 of the position of the code symbol and the CPU 61 may generate display data to be displayed on the display device 106. Since such a warning screen is displayed, the operator can easily identify the barcode BC that is likely to cause basket reading.

If the number of counts is smaller than the predetermined value (NO in Act 11), the CPU 161 proceeds the processing to Act 13 without informing the operator of the warning. In Act 13, the CPU 161 determines whether a job is ended according to end notification or the like for commodity registration from the POS terminal 11. If the job is continued (NO in Act 13), the CPU 161 determines whether predetermined operation by the keyboard 22 is performed, more specifically, whether the closing key 22f is operated (Act 14).

If the closing key 22f is not operated (NO in Act 14), since commodity registration related to one transaction is continuously performed, the CPU 161 returns the processing to Act 2 and continues processing for the next frame image. If the closing key 22f is operated (YES in Act 14), since the commodity registration related to one transaction ends, the CPU 161 resets information concerning the position in the frame image of the detected code symbol and the commodity code decoded by the decoding section 1613 stored in the RAM 163 in association with each other (Act 15). The information stored in the RAM 163 is reset according to predetermined operation by the operator in this way to prevent basket reading from being informed by mistake. For example, the information stored in the RAM 163 is reset at the end of the commodity registration related to one transaction according to the operation of the closing key 22f. This makes it possible to prevent basket reading from being informed in reading of commodities in transactions before and after the transaction.

If the job is ended (YES in Act 13), the CPU 161 outputs an image pickup OFF signal to the image pickup section 164 to end the image pickup by the image pickup section 164 (Act 16) and ends the processing.

A computer program executed by the commodity code reading apparatus 101 according to this embodiment is provided while being incorporated in a ROM or the like in advance. However, the computer program executed by the commodity code reading apparatus 101 according to this embodiment may be provided while being recorded in a computer-readable recording medium such as a CR-ROM, a flexible disk (FD), a CD-R, or a DVD (Digital Versatile Disk) as a file of an installable format or an executable format.

Further, the computer program executed by the commodity code reading apparatus 101 according to this embodiment may be stored on a computer connected to a network such as the Internet and provided by being downloaded through the network. The computer program executed by the commodity code reading apparatus 101 according to this embodiment may be provided or distributed through the network such as the Internet.

The computer program executed by the commodity code reading apparatus 101 according to this embodiment has a module configuration including the sections explained above (the picked-up image capturing section 1611, the code detecting section 1612, the decoding section 1613, the code-position storing section 1614, the determining section 1615, the count section 1616, and the informing section 1617). As actual hardware, a CPU (a processor) reads out the computer program from the ROM and executes the computer program, whereby the sections are loaded onto a main storage device and the picked-up image capturing section 1611, the code detecting section 1612, the decoding section 1613, the code-position storing section 1614, the determining section 1615, the count section 1616, and the informing section 1617 are generated on the main storage device.

What is claimed is:

1. A commodity code reading apparatus comprising:
an image capturing section configured to sequentially capture a frame image picked up by an image pickup section;
a code detecting section configured to detect a code symbol included in the captured frame image;
a decoding section configured to decode a commodity code from the detected code symbol;
a position storing section configured to store a position of the detected code symbol in the frame image;
a determining section configured to determine whether the position of the detected code symbol and a position of a code symbol already stored in the position storing section are close to each other;
a count section configured to count, over a plurality of the sequentially-captured frame images, a number of times the determining section determines that the positions are close to each other; and
an informing section configured to inform, if the counted number of times reaches a number of times set in advance, that it is likely that basket reading of a commodity code occurs, wherein
the commodity code reading apparatus outputs, as a commodity code read from a commodity, a commodity code obtained by decoding a code symbol, a position of which is determined by the determining section as not close to the position of the code symbol already stored in the position storing section.

2. The apparatus according to claim 1, wherein
the position storing section stores the commodity code decoded from the code symbol in association with the position of the detected code symbol in the frame image, and
the count section performs the count if commodity codes decoded from code symbols determined as close to each other by the determining section coincide with each other.

3. The apparatus according to claim 1, wherein the count section resets the counted number of times according to operation by a user received by an operation section.

4. The apparatus according to claim 1, wherein the informing section informs, if a position of a code symbol determined as close to the position of the code symbol already stored in the position storing section is included in a predetermined region, that it is likely that basket reading of a commodity code occurs.

5. The apparatus according to claim 4, wherein the informing section informs, if the position of the determined code symbol is included in a region below a center of the frame image, that it is likely that basket reading of a commodity code occurs.

6. The apparatus according to claim 1, wherein the determining section determines, if a position of a code symbol closest to the position of the detected code symbol among positions of code symbols already stored in the position storing section and the position of the detected code symbol are within a range set in advance, that the positions are close to each other.

7. The apparatus according to claim 1, wherein the position storing section resets the position of the already-stored code symbol according to predetermined operation by a user received by an operation section.

8. The apparatus according to claim 7, wherein the position storing section resets the position of the already-stored code symbol according to an end of commodity registration related to one transaction by predetermined operation by the user.

9. The apparatus according to claim 1, wherein the informing section displays a marker image in a position of a code symbol determined as close to the position of the code symbol already stored in the position storing section to overlap the frame image and informs a code symbol that is likely to cause basket reading.

10. A control method for a commodity code reading apparatus comprising:
sequentially capturing a frame image picked up by an image pickup section;
detecting a code symbol included in the captured frame image;
decoding a commodity code from the detected code symbol;
storing a position of the detected code symbol in the frame image;
determining whether the position of the detected code symbol and a position of an already-stored code symbol are close to each other;
counting, over a plurality of the sequentially-captured frame images, a number of times it is determined that the positions are close to each other; and
informing, if the counted number of times reaches a number of times set in advance, it is likely that basket reading of a commodity code occurs, wherein
a commodity code obtained by decoding a code symbol, a position of which is determined as not close to the position of the code symbol already stored in the position storing section, is output as a commodity code read from a commodity.
